(19) United States
(12) Patent Application Publication
(10) Pub. No.: US 2003/0026887 A1
(43) Pub. Date: Feb. 6, 2003

(54) Use of water-in-oil emulsions for stabilization of oil of frying and boiling under frying conditions

(76) Inventor: Christian Gertz, Hagen (DE)

Correspondence Address: Stephan A. Pendorf, Pendorf & Cutliff, P.O. Box 20445, Tampa, FL, 33622-0445, US

(21) Appl. No.: 10/197,030

(22) Filed: Jul. 17, 2002

(30) Foreign Application Priority Data
Jul. 18, 2001 (DE) 101 34 881.9-41

(51) Int. Cl. A23C 1/00

(52) U.S. Cl. 426/610

(57) ABSTRACT

A water-in-oil emulsion as additive for frying or boiling fat, wherein the water-in-oil emulsion includes antioxidants in combination with water soluble carboxylic acids.

### BACKGROUND OF THE INVENTION

1. Field of the Invention

The term “deep frying” is used to refer to food preparation processes in which consumables, for example, French fries, are heated to approximately 120 to 200° C. while floating in fat in the presence of water which is contained in the consumables. The transmission of heat to the consumable occurs through the frying medium (frying fat).

In the course of thermal stressing, the frying fat is routinely structurally changed. Decomposition products form as a consequence of oxidation and polymerization reactions, which negatively influence the quality of the frying fat. Thereby many factors play a role, such as the type and amount of the material being fried, the quality or nature of the frying process (surface area, volume, type of heat transmission, metal contacts), frying fat (composition, heat stability, addition of fresh oil) and the type of culinary technology (filter) and protective means (use of silicon oils, antioxidants, nitrogen).

During the frying process itself, upon the initial contact of the consumable with the frying medium (oil) an approximately 0.3 mm thick edge-layer is formed, and first free water present in the consumable (for example, French fries) is heated to approximately 100° C. (meat 80° C.) after which it is emitted from the consumable as steam. A temperature front of approximately 100° C. forms, which slowly penetrates into the inside and desorbs the bonded water. Thereby a pressure and temperature gradient forms descending towards the inside of the consumable (material being fried). The high pressure in the edge zone of the consumable in this phase prevents a penetration of fat into the consumable. If there subsequently occurs a condition of insufficient heat, for example due to a too-low of a temperature or too-high of a cooling of the fat (too great of an addition of material being fried), then no water can exit as steam.

During frying the temperature at the core of the consumable (for example French fries) rises to 100° C. Thereby, during frying, water is continuously emitted from the material being fried into the surrounding fat. Thereby an equilibrium is established in the system: frying fat <-> material being fried.

The heat energy supplied to the fryer is primarily consumed for the baking process and not in the decomposition of the frying fat, which would become noticeable by a strong smoking. If the content of soap and other polar decomposition products of the fat increases too strongly, then the water remaining in the consumable is completely given off into the frying fat. French fries, for example, ultimately become hollow inside (unattractive) and the fried material collects more fat on its outer surface as a result of the increased viscosity of the fat in comparison to the product when fresh frying medium is employed, which deteriorating effect becomes discernable not only in the increase of fat consumption during the frying process, but also results in a fatty taste of the fried material (for example French fries).

The type and amount as well as the speed of generation of the thermal oxidative changed fat components formed during frying are essentially dependent upon the composition of the frying fat and the employed temperature. The heat stability of the frying fat plays therein a substantial role. This depends upon the type of the fat. Hard edible fats such as palm oil fat or modified fats are more stable than oils with a higher content of simple and complex unsaturated fatty acids. The heat stability can also be achieved by employment of (a) artificial antioxidants such as TBHQ, gallium compounds, BHA, BHT, dimethylpolysiloxane (silicon), (b) natural antioxidants such as tocopherols, ginger oil extracts, sage oil extracts and rosemary extracts or, as the case may be, concentrates, or (c) special oil mixtures, which have a high content of naturally antioxidative effective materials (for example sesame oil or rice (preferably rice germ) oil).

In contrast to domestic food preparation situations, in which frying oil is used only a few times, the heat stability of the frying fat is the decisive selection criteria for example in the catering area, gastronomic area and in the industrial production of pre-fried fried materials (for example French fries). Besides this, the smell and taste, the visual appearance and the storage stability of the fried product play decisive roles.

Increasingly in the selection of the frying material nutritional physiological aspects, such as a low-as-possible content of trans-fatty acids (for example <10%, preferably <5%, calculated as trigylceride per hundred gram of fat) are used in the selection of the frying fat.

For stabilization of frying fat a so-called “Miroil-fry-powder” is known. This is a powderous preparation of a mineral powder (perlite) with approximately 50% water and 5-10% citric acid, which is directly added to the frying fat in an amount of 20 g/10 kg of fat. The Miroil-fry-powder is however not permissible in certain countries because of the possibility of the uptake of perlite together with the consumables in the case of the direct addition into the fryer.

Optimal frying requires not only a reduction in the spoilage of the fat but rather also an improvement the quality of the fried goods.

### SUMMARY OF THE INVENTION

It is the task of the present invention to provide compositions and processes, which make possible a stabilization of a frying material (frying fat) and preferably at the same time to increase the quality of the fried consumables in comparison to consumables fried in the conventional manner.

The invention is based upon the following incites or recognition, which individually, taken alone, were already partially known, partially however also were not previously known and, in particular, have never been considered together in their combination.

Until now it was generally assumed that the presence of water during a frying process is disadvantageous. More specifically, it was presumed that in frying conditions the frying medium (frying fat) was decomposed primarily hydrolytically, that is, with the involvement of water and under formation of free fatty acids, mono-, diglycerides and glycerin (see S. G. Stevens, et al., JAOCS 61 (1984) 1102).

### DETAILED DESCRIPTION OF THE INVENTION

In the framework of the present invention it has now been confirmed that the water content of a consumable to be fried and the frying fat itself was a factor in the stability of the frying fat and the quality of the fried product (fried consumable). It has however surprisingly been found, that the presence of water in a frying fat in no case has an exclusively negative effect; in contrast, the presence of water can result in a stabilization of the frying medium and to an improvement in the quality of the fried product.

With respect to the hitherto conventional assumption that the presence of water in a frying medium during the frying process results in hydrolysis, it has now surprisingly been found that the presence of water, which is released into the frying fat for example by the material being fried, surprisingly does not result in a change in the proportion of mono- and diglycerides as hydrolytic decomposition products in the frying fat. Since the content of mono- and diglycerides during frying however remains essentially constant, (see Hamilton and E. Perkins, New Developments in Industrial Frying, SCI Barnes & Associates, page 28) it follows that no hydrolysis of the fat components has taken place.

In the framework of the invention it was thus presumed, that the formation of free fatty acids is determined primarily oxidatively, and experiments have shown that the steam escaping out of the frying medium during the frying process (wherein the water originates from the consumables being fried) at least essentially supports or facilitates the direct surface contact of atmospheric oxygen with the frying fat. In addition to this it was determined that the frying fats, during continuous frying of consumables, decomposed substantially slower oxidatively than when heated in the absence of consumables.

The presence of water during the frying process in a frying medium leads however surprisingly not only to a longer stability of the frying medium, which results from a suppression of an oxidative process, but rather leads also to an improvement in the quality of the fried consumable. This positive effect of the water is based upon the factor or effect, that besides a material exchange (transition of water out of the consumable into the frying medium and transition of fat/oil out of the frying medium into the consumable to be fried) there also occurs a thermal exchange between the frying medium (frying fat) and consumable. Conventional frying fats may possess a high thermal capacity, however, transmit the stored heat only poorly to the consumable to be fried, while water possesses a high specific coefficient of transfer, which can be seen from the following table.

| | Specific Thermal Transmission Coefficient |
|---|---|
| Component | according to Sahin [kJ/kg K] |
| Water | 4.182 |
| Protein | 1.550 |
| Fat | 1.670 |
| Carbohydrate | 1.420 |

The presence of water in a frying medium thus leads to an improved thermal transmission from frying medium to the consumable to be fried and therewith to a positive influencing of the quality of the fried consumable.

Beyond the above mentioned advantage, the presence of water in a frying medium, for example—during frying of meat, positively influences the pore size of the crust being formed and leads in particular to an aesthetically appropriate outer texture of the fried consumable.

By employment of the inventive water-in-oil emulsion the stability (usability) of a frying fat can be increased by a multiple (for example, extended to the four-fold of the frying fat in the absence of the inventive emulsion). At the same time during use of the inventive emulsion in a frying fat the quality of the fried product is increased.

In practice, for stabilization of a frying medium, approximately 100 parts by weight of the frying medium (deep frying fat, boiling fat, frying fat) are mixed with one part by weight of the inventive water-in-oil emulsion (mixture relationship emulsion/frying fat=approximately 1/100); however satisfactory results can already be achieved with a mixture relationship of approximately 1/200 (proportion of emulsion approximately 0.5 weight %).

When using the inventive emulsion in a frying fat there results a higher frying productivity, in particular on the basis of the improved thermal transmission. Thus, the temperature of the frying medium during the frying process can in principle be reduced by approximately 10° C. compare to absence of the inventive emulsion. Thereby obviously a substantial savings in energy, in the range of approximately 5-10%, results. A preferred frying temperature during use of the inventive emulsion lies in the range of 160-165° C.

During the use of the inventive emulsion in a frying fat there results in particular during frying of French fries a positive influence on taste. French fries fried using the inventive emulsion taste less strongly like fat and more strongly like potatoes than in the absence of the invention emulsion. Independent of the type of basic frying medium the fried French fries are less saturated with fat.

With respect to French fries it was determined that the fat absorption was reduced by one half when the inventive emulsion was employed in the frying medium. In particular, when using a reduced frying temperature in comparison to the conventional frying processes, the fat uptake an be drastically reduced; this applies not only to French fries but particular to such products as donuts and fish sticks. Thereby the loss of frying fat due to transition of fat into the consumable being fried is substantially reduced. The fried material itself remains warmer substantially longer, and does not come across as saturated with fat after cooling.

When using the inventive emulsion in a frying medium there is hardly any transference of taste from an earlier first fried product to a subsequently fried different product. For example, first fish can be fried and subsequently apple dumplings, without the apple dumplings having a noticeable amount of taste of fried fish.

On the basis of the employment of the inventive emulsion at substantially reduced frying temperatures the fat spoilage is substantially retarded; likewise, certain chemical reactions, which contribute at higher temperatures to a spoilage of fat, do not take place in a lower (frying) temperature.

Preferably the frying temperature is kept below 175° C., in order to avoid the formation of carcinogens, heterocyclic aromatic amines, during the frying process, and also to avoid the decomposition of carboxylic acids.

On the basis of the improved thermal transference from frying medium to the consumable to be fried, when using the inventive emulsion a core temperature in the material to be fried (in the case of French fries approximately 100-102° C.) is more rapidly achieved than in the case of the absence of the employment of the inventive emulsion.

The inventive water-in-oil emulsion may comprise one or more antioxidants (antioxidative agents) in combination with water-soluble carboxylic acids. Carboxylic acids and antioxidants are herein preferably so selected and proportioned relative to each other that the antioxidative and thereby heat stabilization effect of the antioxidants is synergistically improved in comparison to employment of antioxidants alone. The synergistic strengthening is based herein presumably upon a complex interaction of the two components. On the basis of the presence of carboxylic acids and antioxidating agents there is advantageously inhibited also the deposition of polymerization products of the frying fats on the (metallic) surfaces of the fryer.

The water soluble carboxylic acid employed in accordance with the invention is preferably able to complex with metal ions (metal-complexing carboxylic acids); particularly preferred in the framework of the invention are citric acids.

For frying and boiling fats the maximal employable amount of water is unfortunately very small, since the addition of disproportionately large amounts of aqueous solutions or water to the heated frying medium may result in strong splattering or even an explosion. The inventive employment of water-soluble (organic) carboxylic acids in combination with one or more antioxidants, preferably natural or plant derived, produces however the stabilizing effect of the water in excellent manner and leads to a substantial improvement in the antioxidative and heat stabilizing effect of water and antioxidants in comparison to application of the individual components of the inventive emulsion by themselves. Relative to the aqueous phase of the inventive water-in-oil emulsion, the water-soluble carboxylic acid is employed in an amount of for example 5-10 weight %. The water-soluble carboxylic acids (for example citric acids) are as a rule dissolved in an appropriate amount of water prior to the resulting aqueous solution being emulsified into the oil phase. The aqueous phases can of course also have added to them other water soluble substances, such as for example reduced sugars, which facilitate the browning of the consumable by inducing the Maillard reaction. In the case of the employment of citric acids a synergistic enhancing of the antioxidative effect of the one or more employed antioxidation agents is observed. Further, the presence of citric acid inhibits at least substantially the depositing or precipitation of brown polymerization products of the employed frying fat on the metallic surface of the fryer, as has been confirmed by tests.

The antioxidation agents (antioxidants) employed in the course of the invention are preferably employed in the oil phase (fat phase) of the inventive water-in-oil emulsion. Preferred antioxidants (antioxidative effective additives) include tocopherol (tocopherol extract), which contributes in particular to improvement in the storage stability, as well as ascorbyl palmitate, which contributes in particular to a heat stabilization of the frying fat. The use of other antioxidation agents is of course likewise possible.

It can thus be established that preferably the antioxidant or the antioxidation agent is present in the oil (lipophilic) phase, while the aqueous carboxylic acid is present in the aqueous (hydrophilic) phase.

As main component of the oil phase (fat phase) of the inventive water-in-oil emulsion, native and/or non refined edible or food oils are preferably selectively employed. These have a higher heat stabilizing capacity in comparison to refined edible oils (raffinates).

The aqueous phase of an inventive water-in-oil emulsion is preferably an amount of 15-25 weight %, preferably 18-22 weight %, relative to the total amount of the inventive emulsion. The emulsion is stabilized in conventional manner with a conventional emulsifier.

For stabilization of a frying fat (frying medium) the inventive water-in-oil emulsion is added to the frying medium to be stabilized in the desired amount (see above), whereupon the emulsion character tends to be lost. The aqueous phase of the inventive water-in-oil emulsion dissolves or disperses completely in the larger amount of frying fat to which it is added, at least in the heated condition. Preferably such an amount of inventive emulsion is added to the frying fat to be stabilized such that the frying fat is water-saturated at the addition temperature and preferably also at the frying temperature. Thereby the equilibrium between water and consumable (material being fried) and water in the frying fat is advantageously influenced. In particular the oxidation process during frying is retarded on the basis of the water component in the frying fat as already discussed above and the thermal transmission from fat to the consumable to be fried during the heating is improved.

The preferred water-in-oil emulsion comprises

oil (fat) in an amount of 70-90 weight %, preferably 75-85 weight %, wherein in practice an amount of approximately 80 weight % is preferred;

water in an amount of approximately 12-20 weight %, preferably 14-18 weight %, wherein in practice an amount of approximately 16 weight % is preferred;

one or more water soluble carboxylic acids (for example citric acid) in an amount of approximately 0.5-4 weight %, preferably approximately 1-2 weight % in the employed emulsion;

one or more antioxidation agents (antioxidants), for example tocopherol extract and/or ascorbyl palmitate, in an amount of preferably 0.1-1 weight %;

one or more emulsifiers for forming and/or stabilization of the inventive emulsion, as well as

optionally further conventional additives (for example reducing sugar),

wherein the sum of the employed components comprises 100 weight %.

Excellent results were achieved with an emulsion test mixture of 1000 ml, comprised of for example approximately 200-600 ml (preferably 400 ml) native rape seed oil, approximately 200-600 ml (preferably 400 ml) corn germ oil, approximately 100-500 ml (for example 200 ml) of a solution of approximately 10 g citric acid per 100 ml water (10% aqueous solution of citrus acid), approximately 5-20 g (preferably 10 g) emulsifier (see above; preferably fat content 0.1-5%) approximately 1-15 g (preferably 4 g) ascorbyl palmitate (fatty acid ester of ascorbic acid) and optionally as desired approximately 1-10 g (preferably 4 g) tocopherol concentrate (vitamin E), wherein a one-time addition of approximately 1 weight % (relative to the entire amount of frying fat plus added emulsion) (as desired also 0.5-10% addition) of the emulsion to a heated frying fat (frying and boiling fat) occurred. The usability of the frying fat was extended to approximately the four-fold, up to six-fol, by the addition of the inventive test mixture. In tests the walls and heating elements of the fryer remained free of brown deposits, which occur regularly under comparable conditions in the absence of the inventive emulsion. A repeated addition of the inventive emulsion to a frying fat over time, for example, after respectively several hour intervals, for example—eight hours, improved the inventive effect again and lead to an optimization of the frying conditions.

The following example illustrates the advantages which can be achieved by the addition of the inventive emulsion to a frying fat.

### EXAMPLE 1

### Testing of Thermal Decomposition of the Frying Fat Without or, as the Case may be, with Addition of the Inventive Emulsion

To a commercial frying fat based on plant oil there was added 0.4 weight % of an inventive emulsion, which (based on the total inventive emulsion) comprised 80 weight % oil, 16 weight % water, 1-2 weight % citric acid as well as ascorbyl palmitate, tocopherol extract and emulsifiers. In the thus modified frying oil, after the addition of heat, no aqueous phase remained, rather the water completely dissolved in the frying medium.

The treated frying medium was then compared with an otherwise conventional composition for determination of its relative stability.

For this, two fryers were used for frying in parallel, respectively sequentially: French fries, croquettes, breaded schnitzel and breaded fish, wherein frying medium treated with the inventive emulsion was employed in a first fryer and untreated frying medium was employed in the second fryer. After 10 hours one sample of the frying medium was extracted from each of the fryers respectively and the content of polar components was determined, which can be used as a measure or indicator of the thermal decomposition of the frying medium.

While the untreated frying medium was already recognizably spoiled after 25 hours, the amount of polar component in the frying medium treated with the inventive emulsion was still very small even after 50 hours of continuous operation, such that there was no reason not to continue using this frying medium. A dark coloration was observed in the treated frying medium, which was however found to have no effect on the food chemistry and could be traced back to the Millard reaction.

During the test the loss (carrying away by fried food) of treated frying medium was significantly smaller than the loss in the untreated frying medium. The untreated frying medium required addition of 2.5 l untreated oil after 8 hours in order to compensate for the loss of fat, thus overall 22.5 l oil (frying medium) was added. To the treated frying medium in comparison only 0.5 l of oil (frying medium with a proportionate of 0.5 weight % inventive emulsion) was added per 8 hours, in order to compensate for the loss of fat due to the food being fried. Overall 12.5 l of treated oil was added.

### BRIEF DESCRIPTION OF THE DRAWING

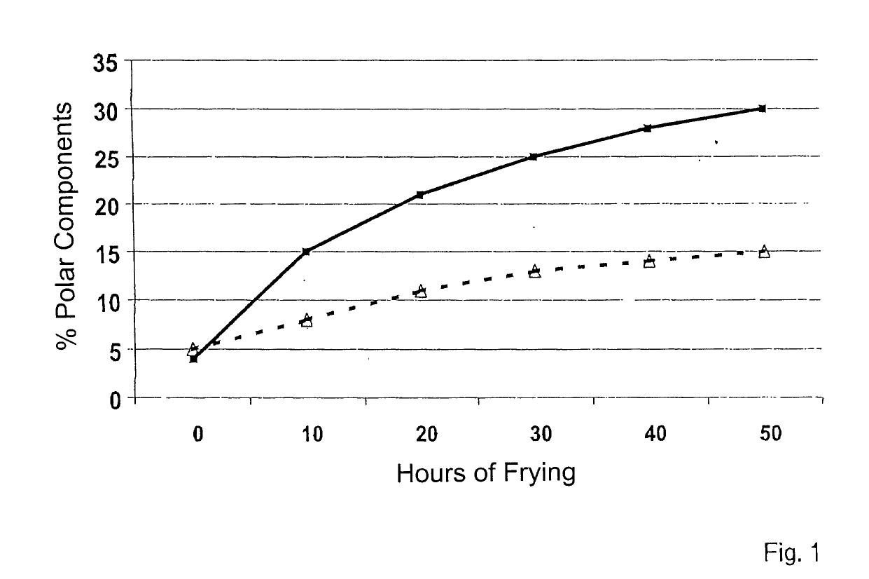

In FIG. 1 the polar component in weight % as a function of frying hours is indicated for both frying mediums, wherein the continuous line indicates the progress of the untreated frying medium and the dashed line the progress of the treated frying medium.

In summary it is noted that by means of the inventive emulsion there is achieved not only an improved stabilization of the frying fat, but rather a sensorial sampling (tasting) of the fried material demonstrated that this was significantly improved with respect to the frying quality. The improvement in the quality of the fried product is a further indicator the excellent suitability of the emulsion as additive (supplement) to the frying fat.

What is claimed is:

1. Water-in-oil emulsion as additive for frying medium, thereby characterized, that the water-in-oil emulsion comprises antioxidants in combination with water soluble carboxylic acids.

2. Water-in-oil emulsion according to claim 1, thereby characterized, that the carboxylic acids are metal complexing.

3. Water-in-oil emulsion according to claim 1 or 2, thereby characterized, that the carboxylic acid is citric acid.

4. Water-in-oil emulsion according to one of claims 1 through 3, thereby characterized, that the carboxylic acid is a 5-10% aqueous solution component of the aqueous phase of the water-in-oil emulsion.

5. Water-in-oil emulsion according to one of claims 1 through 4, thereby characterized, that an oil component of the water-in-oil emulsion is natural or a non-refined food oil.

6. Water-in-oil emulsion according to one of claims 1 through 5, thereby characterized, that the antioxidants include tocopherol and/or ascorbyl palmitate.

7. Water-in-oil emulsion according to one of claims 1 through 6, thereby characterized, that water-in-oil emulsion includes an emulsifier.

8. Water-in-oil emulsion according to claim 7, thereby characterized, that the emulsifier is an ester of mono and diglycerides with fatty acids or organic acids.

9. Water-in-oil emulsion according to claim 7, thereby characterized, that emulsifier is a polycondensed glycerin ester with polycondensed polyacids.

10. Water-in-oil emulsion according to claim 7, thereby characterized, that emulsifier is a polycondensed glycerin ester with recinoleic acid or polycondensed recinoleic acid.

11. Water-in-oil emulsion according to one of claims 1 through 10, thereby characterized, that the water content of the water-in-oil emulsion is 1 to 30 weight %.

12. Water-in-oil emulsion according to one of claims 1 through 10, thereby characterized, that the water-in-oil emulsion comprises
oil (fat) in an amount of 70-90 weight %,
water in an amount of 12-20 weight %,
one or more water soluble carboxylic acids in an amount of 0.5-4 weight %,
one or more antioxidants in an amount of 0.1-1 weight %;
optionally one or more emulsifiers as well as
optionally additional conventional additives,
wherein the amount of the employed components comprises 100 weight %.

13. Use of a water-in-oil emulsion according to one of claims 1 through 12 as additive for a frying medium to be heated.

14. Use of a water-in-oil emulsion according to one of claims 1 through 12 as additive for frying fat to be heated, wherein the proportion of water-in-oil emulsion in the frying fat corresponds to 0.5-10 weight %.

15. Process for stabilization of a frying medium, thereby characterized, that a water-in-oil emulsion according to one of claims 1 through 12 is added to the frying medium.
